(19) United States
(12) Patent Application Publication
(10) Pub. No.: US 2009/0046238 A1
(43) Pub. Date: Feb. 19, 2009

(54) LIQUID CRYSTAL DISPLAY PANEL

(76) Inventors: Kazuya DAISHI, Fukaya-shi (JP); Tetsuya Lizuka, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/172,324

(22) Filed: Jul. 14, 2008

(30) Foreign Application Priority Data
Aug. 13, 2007 (JP) 2007-210873

(51) Int. Cl. G02F 1/1339

(52) U.S. Cl. 349/155

(57) ABSTRACT

A liquid crystal display panel comprises an array substrate having a light blocking portion formed on a substrate, an insulating film that located on the substrate and includes contact holes overlapping the light blocking portion, and pixels including the contact holes, an opposite substrate, a liquid crystal layer, and columnar spacers each located between the array substrate and the opposite substrate so as to straddle the adjacent pixels and to overlap the light blocking portion which is located away from a corresponding one of the contact holes, the columnar spacers holding the gap between the substrates, wherein a cross section of each of the columnar spacers which is parallel to a surface of the array substrate and a surface of the opposite substrate has a major axis, and the major axis crosses a line joining together the contact holes in the pixels overlapped by the spacers.

### CROSS-REFERENCE TO RELATED APPLICATIONS

This application is based upon and claims the benefit of priority from prior Japanese Patent Application No. 2007-210873, filed Aug. 13, 2007, the entire contents of which are incorporated herein by reference.

### BACKGROUND OF THE INVENTION

1. Field of the Invention

The present invention relates to a liquid crystal display panel, and in particular, to a liquid crystal display panel comprising columnar spacers.

2. Description of the Related Art

In recent years, light, small, high-definition liquid crystal display panels have been developed as display panels. In general, the liquid crystal display panel has an array substrate, an opposite substrate arranged opposite to the array substrate with a predetermined gap between the array substrate and the opposite substrate, and a liquid crystal layer held between the array substrate and the opposite substrate. The array substrate has a glass substrate, switching elements formed on the glass substrate, an insulating film formed on the glass substrate and the switching elements, and pixel electrodes formed on the insulating film and electrically connected to the switching elements via contact holes formed in the insulating film.

Plastic beads of a uniform particle size are scattered between the two substrates in order to hold the gap between the substrates constant. Furthermore, for color display, a color filter having colored layers made of red (R), green (G), and blue (B) is located on one of the array substrate and the opposite substrate.

In the liquid crystal display panel configured as described above, the plastic beads are scattered on the substrate by dispersion. Thus, some of the plastic beads may become particles that contaminate a production line to cause defects. Furthermore, the plastic beads present in pixel portions may disturb the orientation of liquid crystal molecules to degrade display quality. Moreover, an uneven dispersion density may result in an inappropriate gap.

As a technique dealing with the above-described problem, as shown in Jpn. Pat. Appln. No. 2001-337345, a configuration has been proposed which has a plurality of columnar spacers formed directly on the array substrate. The columnar spacers are formed on the array substrate by patterning using photolithography or the like. The columnar spacers desirably have a fixed shape in order to hold the gap between the substrates constant. Thus, each of the columnar spacers is formed away from a corresponding one of the contact holes. Furthermore, during the manufacture and use of the liquid crystal display device, to reliably withstand pressure acting on the columnar spacers, each of the columnar spacers desirably has a large cross section and a large contact area over which the columnar spacer contacts the opposite substrate.

For the liquid crystal display panel, an increased definition reduces the distance between pixels and thus the distance between the contact holes. Furthermore, to improve the display quality, the columnar spacers are desirably formed so as to overlap a light blocking portion. Thus, it is difficult to form each of the columnar spacers so as to overlap the light blocking layer while lying away from the corresponding contact hole. To be formed so as to overlap the light blocking layer while lying away from the corresponding contact hole, each of the columnar spacers may have a reduced size.

However, in this case, the columnar spacers are thinner, and a contact portion of each of the columnar spacers has a reduced contact area. A heavy load acts on the contact portion. Thus, when an external force acts on the substrate, the columnar spacers may be deformed. This makes it difficult to hold the gap between the array substrate and the opposite substrate constant. As a result, the liquid crystal display panel may provide inappropriate display.

### BRIEF SUMMARY OF THE INVENTION

The present invention is made in view of these points. An object of the present invention is to provide a liquid crystal display device that provides a high image quality.

To achieve the object, according to an aspect of the present invention, there is provided a liquid crystal display panel comprising:

an array substrate having a light blocking portion formed on a substrate, an insulating film that located on the substrate and includes contact holes overlapping the light blocking portion, and pixels including the contact holes;

an opposite substrate arranged opposite to the array substrate with a gap between the array substrate and the opposite substrate;

a liquid crystal layer held between the array substrate and the opposite substrate; and

columnar spacers each located between the array substrate and the opposite substrate so as to straddle the adjacent pixels and to overlap the light blocking portion which is located away from a corresponding one of the contact holes, the columnar spacers holding the gap between the array substrate and the opposite substrate,

wherein a cross section of each of the columnar spacers which is parallel to a surface of the array substrate and a surface of the opposite substrate has a major axis, and

the major axis of each of the columnar spacers crosses a line joining together the contact holes in the pixels overlapped by the spacers.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a liquid crystal panel according to an embodiment of the present invention;

FIG. 2 is a plan view of an array substrate shown in FIG. 1;

FIG. 3 is an enlarged plan view showing a part of the array substrate shown in FIGS. 1 and 2;

FIG. 4 is an equivalent circuit diagram of the array substrate shown in FIG. 3;

FIG. 5 is a sectional view of the liquid crystal display panel shown in FIG. 3, the sectional view being taken along line V-V in FIG. 3;

FIG. 6 is a sectional view of the liquid crystal display panel shown in FIG. 3, the sectional view being taken along line VI-VI in FIG. 3;

FIG. 7 is an enlarged plan view showing a part of the array substrate, particularly, contact holes, pixel electrodes, and a columnar spacer; and

FIG. 8 is an enlarged plan view showing a part of an array substrate in a liquid crystal display panel according to another embodiment of the present invention, particularly, contact holes, pixel electrodes, and columnar spacers.

### DETAILED DESCRIPTION OF THE INVENTION

A liquid crystal display panel according to an embodiment of the present invention will be described below with reference to the drawings.

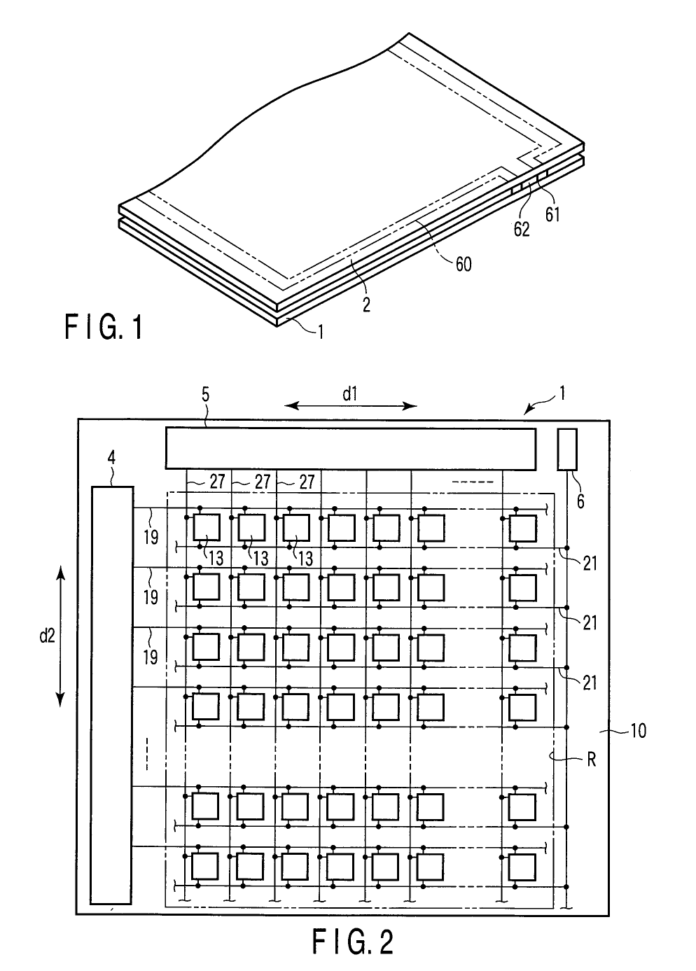

As shown in FIGS. 1, 5, and 6, the liquid crystal display panel comprises an array substrate 1, an opposite substrate 2 arranged opposite to the array substrate, and a liquid crystal layer 3 held between the array substrate 1 and the opposite substrate 2. The liquid crystal display panel has a display area R in which the array substrate 1 and the opposite substrate 2 overlap each other. The array substrate 1 has a plurality of pixels 13 arranged in the display area R in a matrix. The pixels 13 will be described below.

As shown in FIG. 2, outside the display area R, a scanning line driving circuit 4, a signal line driving circuit 5, and an auxiliary capacitance line driving circuit 6 are formed on the glass substrate 10. The scanning line driving circuit 4 is connected to a plurality of scanning lines 19 extending to the outside of the display area R. The signal line driving circuit 5 is connected to a plurality of signal lines 27 extending to the outside of the display area R. The auxiliary capacitance line driving circuit 6 is connected to a plurality of auxiliary capacitance lines 21 extending to the outside of the display area R.

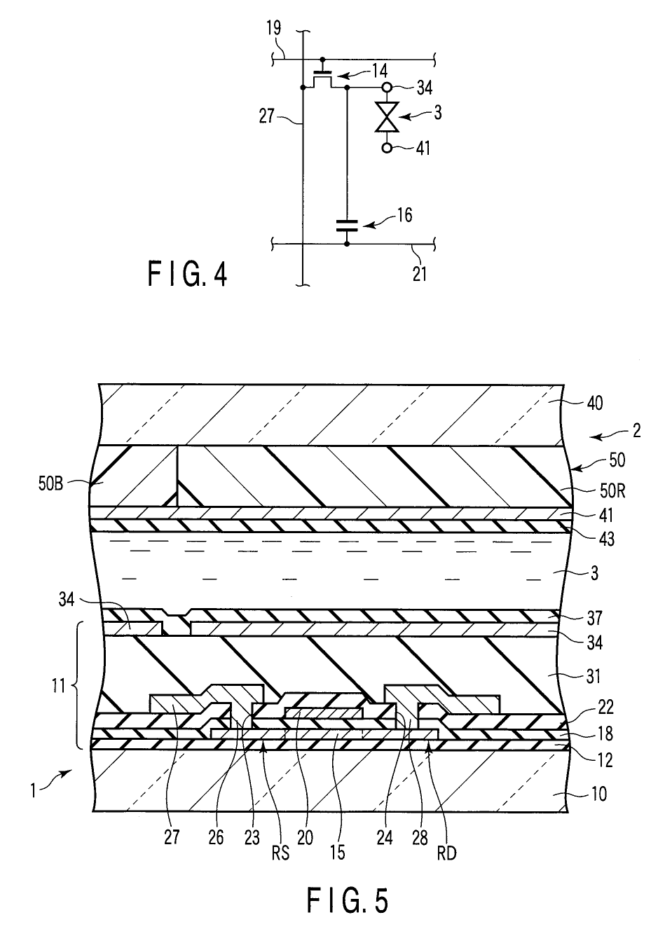

As shown in FIGS. 1 to 6, the array substrate 1 comprises, for example, a glass substrate 10 as a transparent insulating substrate. An undercoating layer 12 is deposited on the glass substrate 10.

In the display area R, the plurality of scanning lines and the plurality of signal lines 27 are arranged on the glass substrate 10; the scanning lines 19 extend along a first direction d1 and the signal lines 27 extend along a second direction d2 orthogonal to the first direction. The plurality of auxiliary capacitance lines 21 parallel to the scanning lines 19 are formed on the glass substrate 10. In the present embodiment, the auxiliary capacitance lines 21 function as a light blocking portion. Pixels 13 are each formed in an area enclosed by the two adjacent signal lines 27 and the two adjacent auxiliary capacitance lines 21.

One of the pixels 13 will be described.

As shown in FIGS. 2 to 6, the pixel 13 has a pixel electrode 34, thin-film transistor (TFT) 14 as a switching element connected to the pixel electrode, and an auxiliary capacitance element 16.

Specifically, a channel layer 15 and an auxiliary capacitance electrode 17 are formed on the undercoating layer 12. The channel layer 15 and the auxiliary capacitance electrode 17 are simultaneously formed by using the same material and patterning a semiconductor film formed on the undercoating layer 12. In the present embodiment, the channel layer 15 and the auxiliary capacitance electrode 17 are formed of polysilicon.

A gate insulating film 18 is deposited on the undercoating layer 12, the channel layer 15, and the auxiliary capacitance electrode 17. The following are formed on the gate insulating film 18: the plurality of scanning lines 19, a plurality of gate electrodes 20 formed by extending parts of the scanning lines 19, and the plurality of auxiliary capacitance lines 21. In an area overlapping the auxiliary capacitance electrode 17, an opening 21a is formed in the auxiliary capacitance line 21.

The scanning lines 19, the gate electrodes 20, and the auxiliary capacitance lines 21 are simultaneously formed using a low-resistance material such as aluminum or molybdenum-tungsten which exerts a light blocking effect. In the present embodiment, the scanning lines 19, the gate electrodes 20, and the auxiliary capacitance lines 21 are formed of molybdenum-tungsten.

Each of the gate electrodes 20 is formed so as to overlap the corresponding channel layer 15. Each of the auxiliary capacitance lines 21 is formed so as to overlap a plurality of the auxiliary capacitance electrodes 17. The auxiliary capacitance electrode 17 and auxiliary capacitance line 21 arranged opposite to each other via the gate insulating film 18 form the auxiliary capacitance element 16.

An interlayer insulating film 22 is formed on the gate insulating film 18, the scanning lines 19, the gate electrodes 20, and the auxiliary capacitance lines 21. The following are formed on the interlayer insulating film 22: a plurality of source electrodes 26, the plurality of signal lines 27, a plurality of drain electrodes 28, a plurality of connection wires 29, and a plurality of contact electrodes 30.

Each of the source electrodes 26 and the corresponding one of the signal lines 27 are integrally formed and electrically connected together. Each of the plurality of drain electrodes 28, the corresponding one of the plurality of connection wires 29, and the corresponding one of the plurality of contact electrodes 30 are integrally formed and electrically connected together.

Each of the source electrodes 26 is electrically connected to a source region RS in the channel layer 15 via a contact hole 23 penetrating a part of the gate insulating film 18 and a part of the interlayer insulating film 22. Each of the drain electrodes 28 is electrically connected to a drain region RD in the channel layer 15 via a contact hole 24 penetrating a part of the gate insulating film 18 and a part of the interlayer insulating film 22.

Each of the contact electrodes 30 is electrically connected to the corresponding auxiliary capacitance electrode 17 via a contact hole 25 penetrating a part of the gate insulating film 18 and a part of the interlayer insulating film 22. The contact hole 25 passes through the opening 21a in the auxiliary capacitance line 21. This maintains an insulating condition between the contact electrode 30 and the auxiliary capacitance line 21.

The source electrodes 26, the signal lines 27, the drain electrodes 28, the connection wires 29, and the contact electrodes 30 are simultaneously formed using a low-resistance material such as aluminum or molybdenum-tungsten which exerts a light blocking effect. In the present embodiment, the source electrodes 26, the signal lines 27, the drain electrodes 28, the connection wires 29, and the contact electrodes 30 are formed of aluminum.

A flattening film 31 formed of a transparent resin is deposited on the interlayer insulating film 22, the source electrodes 26, the signal lines 27, the drain electrodes 28, the connection wires 29, and the contact electrodes 30, as an insulating film. In the present embodiment, the flattening film 31 is an organic insulating film. The flattening film 31 has a plurality of contact holes 32 formed so as to overlap the respective auxiliary capacitance lines 21 and the respective contact electrodes 30.

A plurality of pixel electrodes 34 are formed on the flattening film 31 using a transparent conductive material such as indium tin oxide (ITO). The pixel electrodes 34 are arranged in a matrix. Each of the pixel electrodes 34 is electrically connected to the contact electrode 30 via a contact hole 32. The pixel electrode 34 is formed such that the periphery of the pixel electrode 34 overlaps the two signal lines 27 and two auxiliary capacitance lines 21 which are all adjacent to the pixel electrode 34. The pixel electrode 34 has a major axis in a direction along the signal lines 27.

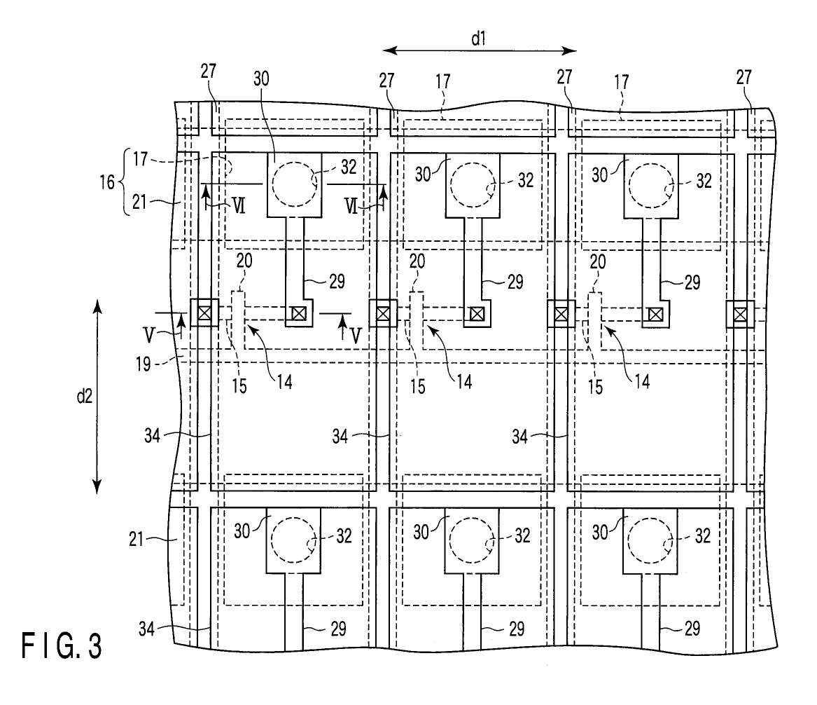

As described above, an under layer 11 having TFT 14, the auxiliary capacitance elements 16, and the pixel electrodes 34 is formed on the glass substrate 10. A plurality of columnar spacers 35 are each formed on the under layer 11 away from a corresponding one of the plurality of contact holes 32. In FIG. 3, the illustration of the columnar spacers 35 is omitted. An alignment film 37 is formed on the under layer 11, on which the columnar spacers 35 are formed.

Each of the plurality of pixels 13 has one TFT 14, one auxiliary capacitance element 16, one contact hole 32, and one pixel electrode 34.

Now, the opposite substrate 2 will be described.

As shown in FIGS. 1, 4, 5, and 6, the opposite substrate 2 comprises, for example, a glass substrate 40 as a transparent insulating substrate. A color filter 50 is formed on the glass substrate 40.

The color filter 50 has a plurality of red colored layers 50R, a plurality of green colored layers 50G, and a plurality of blue colored layers 50B. The colored layers are formed in a stripe pattern and parallel to the direction in which the signal lines 27 extend. The periphery of each of the colored layers overlaps the corresponding signal line 27. An opposite electrode 41 is formed on the color filter 50 using a transparent conductive material such as ITO. An alignment film 43 is formed on the color filter 50 and the opposite electrode 41.

The array substrate 1 and the opposite substrate 2 are arranged opposite to each other with a predetermined gap between the array substrate 1 and the opposite substrate 2 by the plurality of columnar spacers 35. The array substrate 1 and the opposite substrate 2 are joined together by a sealing member 60 located between the array substrate 1 and the opposite substrate 2 around an outer periphery of the display area R. The liquid crystal layer 3 is formed in an area enclosed by the array substrate 1, the opposite substrate 2, and the sealing member 60. A liquid crystal injection port 61 is formed in a part of the seal material 60. The liquid crystal injection port is sealed with a sealant 62.

Now, the above described columnar spacers 35 will be described.

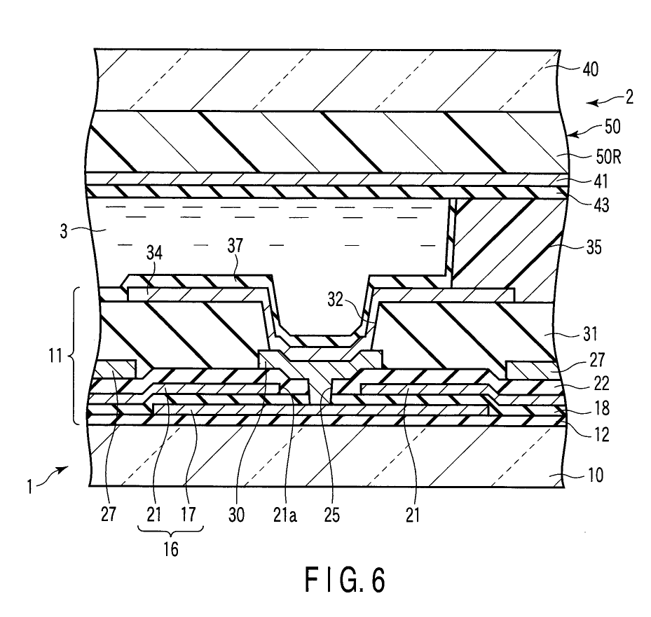

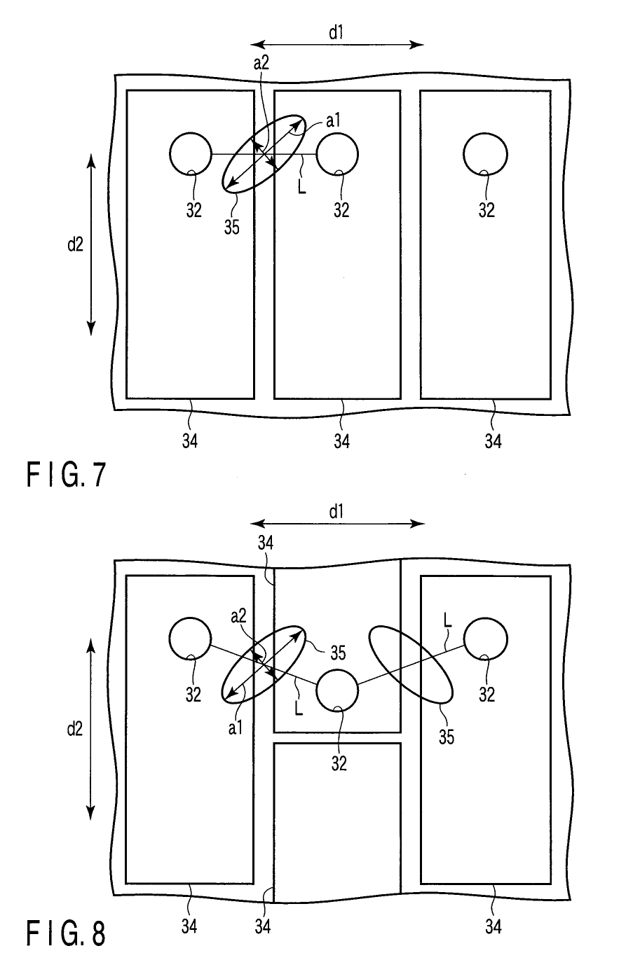

As shown in FIGS. 6 and 7, each of the columnar spacers 35 overlaps a part of the corresponding auxiliary capacitance line 21 which is located away from the corresponding contact hole 32. The columnar spacer 35 straddles the pixels 13 arranged adjacent to each other in the first direction d1. In the present embodiment, the columnar spacer 35 straddles the pixel electrodes 34 arranged adjacent to each other in the first direction d1.

A cross section of the columnar spacer 35 which is parallel to a surface of the array substrate 1 and a surface of the opposite substrate 2 has a major axis al. The major axis a1 of each columnar spacer 35 crosses a line L joining together the contact holes 32 in the pixels 13 overlapped by the columnar spacer. The line L is a straight line along the first direction d1.

In the present embodiment, the columnar spacer 35 is an elliptic column, and the cross section of the columnar spacer 35 which is parallel to the surface of the array substrate 1 and the surface of the opposite substrate 2 is elliptic. The cross section of the columnar spacer 35 has the major axis a1 and a minor axis a2 which are orthogonal to each other. The center of each columnar spacer 35 is positioned at the center of the line L.

In the liquid crystal display panel configured as described above, each of the columnar spacers 35 overlaps the part of the corresponding auxiliary capacitance line 21 which is located away from the corresponding contact hole 32. The columnar spacer 35 straddles the adjacent pixels 13. The major axis a1 of each columnar spacer 35 crosses the line L joining together the contact holes 32 in the pixels 13 overlapped by the columnar spacer.

Thus, even if the increased definition of the liquid crystal display panel reduces the distance between the pixels 13 or the distance between the contact holes 32, large-sized columnar spacers 35 can be formed so as to overlap the respective auxiliary capacitance lines 21.

The columnar spacers 35 can be inhibited from being deformed by the effect of an external force on the substrate. Since the gap between the array substrate 1 and the opposite substrate 2 can be held constant, the display quality of the liquid crystal display panel can be inhibited from being degraded. Furthermore, since the columnar spacers 35 can be formed so as to overlap the respective auxiliary capacitance lines 21, the display quality can be improved.

As described above, the liquid crystal display panel obtained offers a high display quality and a high production yield.

Now, a detailed description will be given of a liquid crystal display panel according to another embodiment of the present invention. The part of the configuration of the present embodiment which will not be described below is the same as that of the above-described embodiment. The same components of the present embodiment as those of the above-described embodiment are denoted by the same reference numbers and will not be described below in detail.

As shown in FIG. 8, the plurality of pixels 13 (pixel electrodes 34) are arranged in the first direction d1 so as to be misaligned in the second direction d2 and are arranged in a line in the second direction. More specifically, in the first direction d1, each of the plurality of odd number-th pixels 13 and the succeeding one of the plurality of even number-th pixels 13 are misaligned in the second direction d2.

The pixel arrangement shown in FIG. 8 enables a reduction in parasitic capacitance that may occur between the pixels. This makes it possible to prevent the image quality from being degraded by cross talk or the like.

The contact holes 32 are staggered in the first direction d1. The major axis a1 of each columnar spacer 35 crosses the line L joining together the contact holes 32 in the pixels 13 overlapped by the columnar spacer. The line L is a straight line inclined to the first direction d1 and the second direction d2.

In the liquid crystal display panel configured as described above, each of the columnar spacers 35 overlaps the part of the corresponding auxiliary capacitance line 21 which is located away from the corresponding contact hole 32. The columnar spacer 35 straddles the adjacent pixels 13. The major axis a1 of each columnar spacer 35 crosses the line L joining together the contact holes 32 in the pixels 13 overlapped by the columnar spacer. Thus, the present embodiment can exert effects similar to those of the above-described embodiment.

As described above, the liquid crystal display panel obtained offers a high display quality and a high production yield.

The present invention is not limited to the as-described embodiments. In an implementation stage, the components of the embodiments can be varied without departing from the spirit of the present invention. Furthermore, various inventions can be formed by appropriately combining a plurality of the components disclosed in the above-described embodiments. For example, some of the components shown in the embodiments can be deleted. Moreover, components of the different embodiments may be appropriately combined together.

Furthermore, the above-described embodiments are effectively applied to the pixel electrodes 34 having short sides (the first direction d1 in FIGS. 7 and 8) of at most 50 μm. When the pixel electrodes have short sides of at most 50 μm, the distance between the pixel electrodes and the distance between the contact holes are reduced. However, with the above-described embodiments, when the columnar spacer is placed between the contact holes, the columnar spacer need not be thinned but can maintain a sufficient thickness. A contact portion of the columnar spacer can thus have a sufficient contact area. Consequently, even if a heavy load acts on the contact portion, the columnar spacer is prevented from being deformed. Therefore, the gap between the array substrate and the opposite substrate can be held constant. The liquid crystal display panel can thus provide appropriate display.

The sectional shape of the columnar spacer 35 is not limited to the eclipse but may be a rectangle or a cross. The cross section of the columnar spacer 35 has only to have the major axis a1. Then, the above-described effects can be exerted provided that the major axis a1 of the columnar spacer 35 crosses the line joining together the contact holes 32 in the pixels 13 overlapped by the columnar spacer 35.

The shape of the pixel electrode 34 may be modified such that the columnar spacer 35 is formed away from the corresponding pixel electrode 34. The columnar spacers 35 need not be formed on the array substrate 1 but may be formed on the opposite substrate 2. The color filter 50 may be formed on the opposite substrate 2. The columnar spacer 35 need not overlap the corresponding auxiliary capacitance line 21 but has only to overlap a member functioning as a light blocking portion.

What is claimed is:

1. A liquid crystal display panel comprising:
an array substrate having a light blocking portion formed on a substrate, an insulating film that located on the substrate and includes contact holes overlapping the light blocking portion, and pixels including the contact holes;
an opposite substrate arranged opposite to the array substrate with a gap between the array substrate and the opposite substrate;
a liquid crystal layer held between the array substrate and the opposite substrate; and
columnar spacers each located between the array substrate and the opposite substrate so as to straddle the adjacent pixels and to overlap the light blocking portion which is located away from a corresponding one of the contact holes, the columnar spacers holding the gap between the array substrate and the opposite substrate,
wherein a cross section of each of the columnar spacers which is parallel to a surface of the array substrate and a surface of the opposite substrate has a major axis, and
the major axis of each of the columnar spacers crosses a line joining together the contact holes in the pixels overlapped by the spacers.

2. The liquid crystal display panel according to claim 1, wherein the pixels are arranged in a matrix in a first direction and a second direction which are orthogonal to each other, and
each of the columnar spacers straddles the pixels located adjacent to each other in the first direction.

3. The liquid crystal display panel according to claim 1, wherein the pixels are arranged in the first direction so as to be misaligned in the second direction orthogonal to the first direction, and are arranged in a line in the second direction.

4. The liquid crystal display panel according to claim 1, wherein a cross section of each of the columnar spacers which is parallel to the surface of the array substrate and the surface of the opposite substrate is elliptic.

5. The liquid crystal display panel according to claim 1, wherein a center of each of the columnar spacers is positioned at a center of a line joining the contact holes together.
